(19) United States
(12) Patent Application Publication
(10) Pub. No.: US 2010/0195139 A1
(43) Pub. Date: Aug. 5, 2010

(54) PRINT RENDERING VERIFICATION

(75) Inventors: Mariyan D. Fransazov, Sammamish, WA (US); Vijay Rajasekharuni, Redmond, WA (US); Georgi M. Chalakov, Duvall, WA (US); Gheorghe Velcsov, Redmond, WA (US); Georgi K. Nikolov, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/365,725

(22) Filed: Feb. 4, 2009

(51) Int. Cl. G06F 3/12

(52) U.S. Cl. 358/1.15

(57) ABSTRACT

Print rendering verification is described. In embodiments, a PDL (Page Description Language) print file can be received where the PDL print file is generated when a print job of a printable image is initiated. A raster image can then be generated from the PDL print file. The raster image can be compared to a reference image that corresponds to the raster image, where the reference image is a comparative standard by which to evaluate print quality of the printable image. A determination can then be made as to whether the printable image is an acceptable quality based on the comparison of the raster image to the reference image.

### BACKGROUND

Most computer applications designed for user interface include a print functionality so that a user can print documents with images, text, graphics, and the like. The development of print functionality and verification of print quality is manually intensive and prone to subjective results. When a computer application initiates a print job, a combination of the application, print drivers, and a graphic interface produce print data in a Page Description Language (PDL) format that can be routed to a printer to print a document or other resultant image. However, a PDL file is difficult to parse and compare for print quality due to the high complexity of PDL, the many proprietary language extensions and/or driver optimizations that may be included with the PDL, and because there is not currently a viewer for PDL files.

A typical technique used to verify a resultant image against a reference image involves output of the images to a display device or physical media for a visual comparison of the images, such as manually by a developer or other person. If differences in print quality are noted by visual comparison, a developer can make software changes to enhance a resultant image and more closely match the reference image. However, this traditional technique of a manual comparison for print quality verification can be labor intensive, and may provide subjective results and/or is subject to human error.

### SUMMARY

This summary is provided to introduce simplified concepts of print rendering verification. The simplified concepts are further described below in the Detailed Description. This summary is not intended to identify essential features of the claimed subject matter, nor is it intended for use in determining the scope of the claimed subject matter.

Print rendering verification is described. In embodiments, a PDL (Page Description Language) print file can be received where the PDL print file is generated when a print job of a printable image is initiated. A raster image can then be generated from the PDL print file. The raster image can be compared to a reference image that corresponds to the raster image, where the reference image is a comparative standard by which to evaluate print quality of the printable image. A determination can then be made as to whether the printable image is an acceptable quality based on the comparison of the raster image to the reference image.

In other embodiments, a delta can be generated when the raster image is compared to the reference image, where the delta indicates a difference in the print quality of the printable image. The determination as to whether the printable image is an acceptable quality can be further based on a comparison of the delta with an acceptable quality deviation. In addition, an output data file can be generated that includes comparison results when the raster image is compared to the reference image.

In other embodiments, a reference PDL print file can be received when a print job is initiated for the printable image, and the reference image can be generated from the reference PDL print file. The reference image can then be stored for comparison with subsequent print jobs of the printable image. In addition, the printable image can be stored from which to initiate subsequent print jobs.

In other embodiments, an updated PDL print file can be received after a print component that is utilized to generate PDL print files has been updated, such as a print driver, an operating system programmable graphic interface, or an application that initiates the print job of the printable image. An updated raster image can be generated from the updated PDL print file, and the updated raster image can be compared to the reference image. A determination can then be made as to whether the printable image is an acceptable quality based the comparison of the updated raster image to the reference image after the print component has been updated.

### BRIEF DESCRIPTION OF THE DRAWINGS

Embodiments of print rendering verification are described with reference to the following drawings. The same numbers are used throughout the drawings to reference like features and components:

FIG. 1 illustrates an example system in which embodiments of print rendering verification can be implemented.

FIG. 2 illustrates another example system in which embodiments of print rendering verification can be implemented.

FIG. 3 illustrates example method(s) for print rendering verification in accordance with one or more embodiments.

FIG. 4 illustrates example method(s) for print rendering verification in accordance with one or more embodiments.

FIG. 5 illustrates example method(s) for print rendering verification in accordance with one or more embodiments.

FIG. 6 illustrates various components of an example device that can implement embodiments of print rendering verification.

### DETAILED DESCRIPTION

Embodiments of print rendering verification provide techniques to implement paperless and automated PDL (Page Description Language) rendering verification. When a software application, print drivers, operating system, graphic interface, or other print components are being developed or updated as part of an image rendering system, a reference image can be produced before the update. After the software update, a resultant image can be compared to the reference image to verify the quality of the print rendering. Embodiments of print rendering verification are application-agnostic and are applicable to the development and/or to an update of any application that includes or incorporates print functionality.

The first time that a printable image is initiated as a print job and a PDL print file is generated from components of a print rendering system, a raster image can be generated from the PDL print file. The raster image can then be stored or otherwise maintained as the reference image that is the comparative standard by which to evaluate print quality of subsequent printable images. After a software update to a print component, the printable image can again be initiated as a print job, and the resultant raster image that is generated from the update PDL print file can be compared to the reference image to determine whether the printable image is still of an acceptable quality. If the quality of the printable image notably changes after the software update, then a developer will know that the software update to the print component may have caused a change, regression, or degradation in the print rendering.

While features and concepts of the described systems and methods for print rendering verification can be implemented in any number of different environments, systems, and/or various configurations, embodiments of print rendering verification are described in the context of the following example systems and environments.

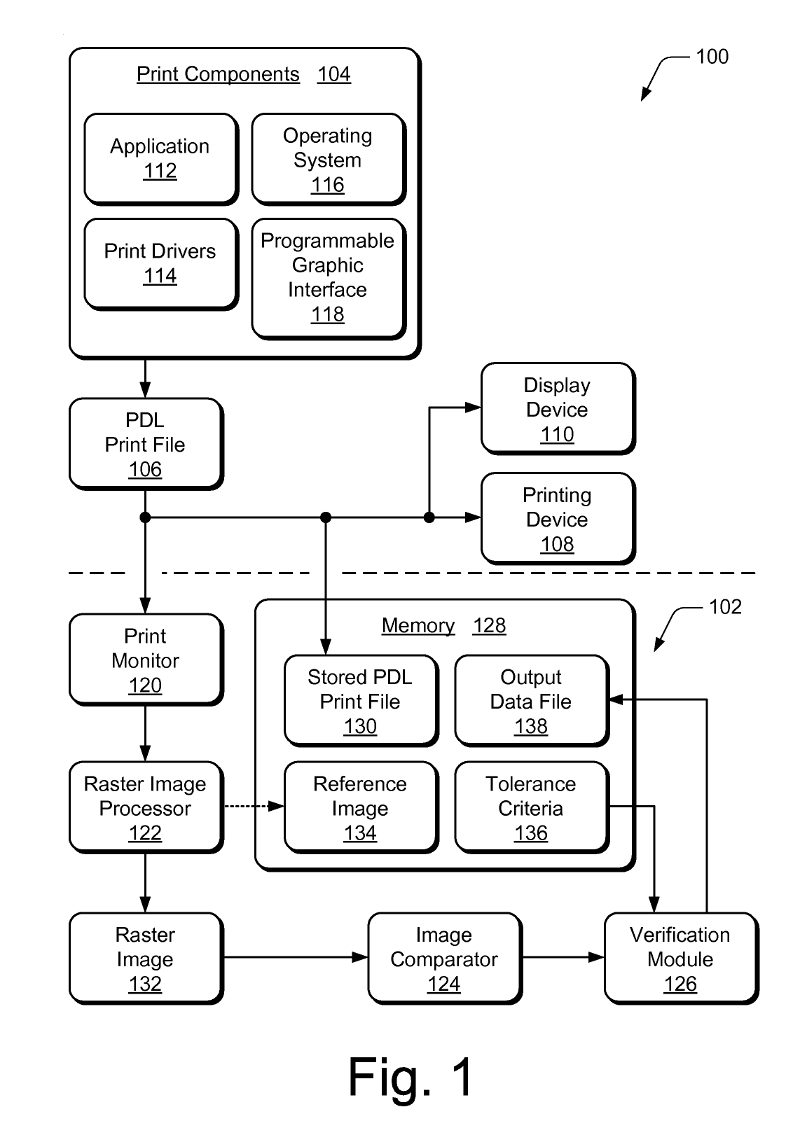

FIG. 1 illustrates an example system 100 in which various embodiments of print rendering verification can be implemented. System 100 includes an example of a print rendering verification system 102 that can be implemented for paperless and automated PDL (Page Description Language) rendering verification of a printable image. System 100 includes examples of print components 104, such as the print components that can be implemented in a computer device to initiate a print job of a printable image and generate a PDL print file 106 that defines elements of the printable image. A printable image can include any combination of text, graphics, images, and the like that is processed to be printed at a printing device 108 or displayed on a display device 110.

The print components 104 can be implemented either individually or integrated to process printable image data to generate the PDL print file 106. The various print components 104 include an application 112 that initiates a print job of the printable image, print drivers 114 that generate the PDL print file 106 and interface with printing device 108, an operating system 116, and/or a programmable graphic interface 118 that is integrated with the operating system 116. The programmable graphic interface 118 can be implemented to interface with various commercial and/or third-party print drivers and software to generate a PDL print file.

A PDL print file is difficult to parse, view, or analyze reliably in the vector space. In embodiments of print rendering verification, a PDL print file is converted to a raster image in the raster space (e.g., a raster bitmap). A raster image or bitmap represents an image in a series of bits of information which translate into pixels on a display device and can be generated in a variety of formats, including a .gif, .jpg, .bmp, or .tiff format. The .tiff format (Tag Image File Format) is an image format that can be utilized to exchange raster graphics (e.g., bitmaps and images). Embodiments of print rendering verification provide paperless and automated print quality verification of a print output.

The first time that a printable image is initiated as a print job and a PDL print file is generated, a raster image can be generated from the PDL print file. The raster image can then be stored or otherwise maintained as a reference image that is a comparative standard by which to evaluate print quality of subsequent printable images. For example, when a software application, print drivers, operating system, graphic interface, or other print component that is part of an image rendering system is being developed or updated, the reference image can be generated before the update. After the software update, the printable image can again be initiated as a print job, and the resultant raster image that is generated from the update PDL print file can be compared to the reference image to determine whether the printable image is still of an acceptable quality. If the quality of the printable image notably changes after the software update, then a developer will know that the software update to the print component may have caused a change, regression, or degradation in the print rendering.

The example of a print rendering verification system 102 includes a print monitor 120 (also referred to as an interceptor entity), a raster image processor (RIP) 122, an image comparator 124, and a verification module 126. The system 102 also includes a memory 128 to store or otherwise maintain data associated with the print rendering verification system 102. For example, a PDL print file 106 can be stored in memory 128 as a stored PDL print file 130. The print monitor 120, raster image processor 122, image comparator 124, and verification module 126 can each be implemented as computer-executable instructions and executed by processors of a computer device to implement embodiments of print rendering verification.

Although illustrated and described as independent software modules or device applications, any combination of the print monitor 120, raster image processor 122, image comparator 124, and verification module 126, as well as other functionality to implement the various embodiments described herein, can be implemented together as a single application or service. Alternatively or in addition, any combination of the print monitor 120, raster image processor 122, image comparator 124, and verification module 126 can be implemented as separate services and/or on separate devices.

The print monitor 120 can be implemented to intercept a PDL print file 106 when a print job of a printable image is initiated, such as when any one or more of the print components 104 initiate a print job and generate the PDL print file 106. The raster image processor 122 can be implemented to generate a raster image 132 from the PDL print file 106. The raster image processor 122 converts images in the form of vector graphics (e.g., a PDL print file) into raster graphics images or bitmaps. The first time that a printable image is initiated as a print job from the print components 104, a raster image can be generated from the PDL print file 106. The raster image can then be stored or otherwise maintained as a reference image 134 that is a comparative standard by which to evaluate print quality of subsequent printable images. The reference image 134 can be physically verified as the comparative standard, and then utilized for paperless and automated print quality verification of subsequent print jobs of the printable image.

The image comparator 124 can be implemented to compare the raster image 132 to the reference image 134 (e.g., the respective reference image that corresponds to the particular raster image). The image comparator 124 can then generate a delta that indicates a difference in the print quality of the printable image when the raster image is compared to the reference image. In an embodiment, the comparison result is a quantifiable raster difference (e.g., the delta) that can be evaluated to pass or fail the print job depending on whether the resulting delta is within a predetermined delta range. The image comparator 124 can be implemented to compare a raster image 132 with the reference image 134 pixel-by-pixel to verify whether the images are binary equivalents, and/or implement image processing algorithms to determine minor deviations (e.g., the delta).

The verification module 126 can be implemented to determine whether the printable image is an acceptable quality based on the comparison of the raster image 132 to the reference image 134, and/or based on a comparison of the delta with an acceptable quality deviation (e.g., tolerance criteria 136, user-specified pass criteria, etc.). The verification module 126 can further be implemented to generate an output data file 138 that includes comparison results when the raster image is compared to the reference image. The output data file 138 can include a log of errors, indications of pass or fail for a printable image, associated text information, and other error data to analyze failed print rendering verification.

After a software update to a print component 104 that is utilized to generate a PDL print file 106, such as an updated print driver 114 or a development update to the programmable graphic interface 118, a printable image can again be initiated as a print job. The print monitor 120 can intercept the updated PDL print file 106 and the raster image processor 122 can generate an updated raster image 132 from the updated PDL print file 106. The resultant raster image 132 that is generated from the corresponding PDL print file 106 can then be compared to the reference image 134 by the image comparator 124 to determine whether the printable image is still of an acceptable quality. The verification module 126 can then determine whether the printable image is the acceptable quality based on the comparison of the updated raster image to the reference image after the print component has been updated.

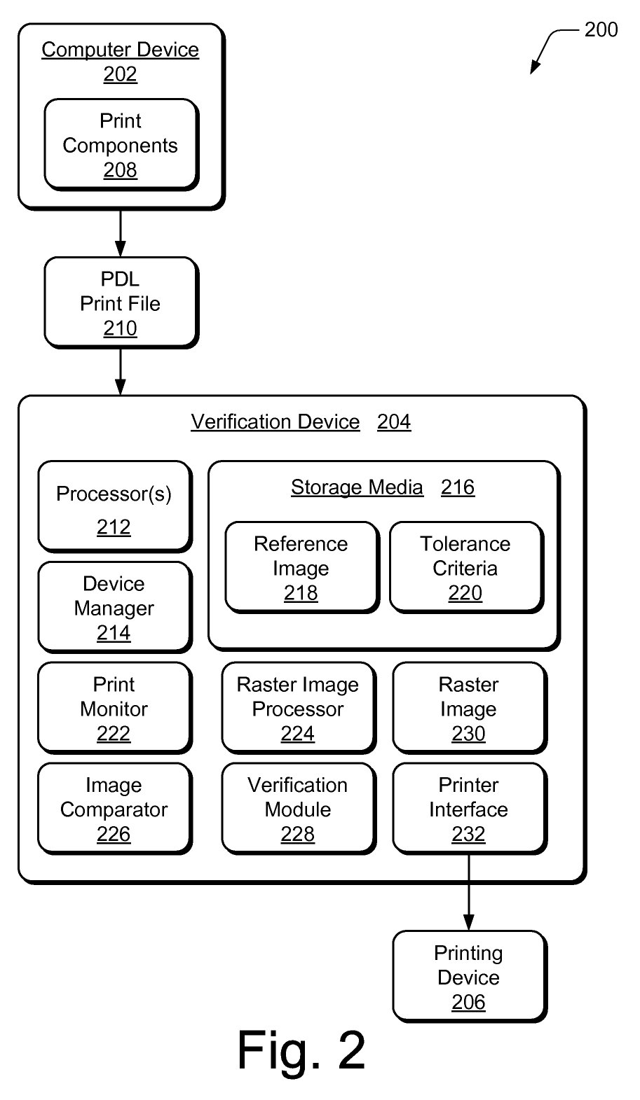

FIG. 2 illustrates an example system 200 in which various embodiments of print rendering verification can be implemented. Example system 200 includes a computer device 202, a verification device 204, and a printing device 206. In this example, the computer device 202 includes various print components 208 that can be implemented to initiate a print job of a printable image and generate a PDL print file 210. The print components 208 can include any one or combination of applications that initiate a print job of the printable image, print drivers that generate the PDL print file 210, an operating system, and/or a programmable graphic interface that is integrated with the operating system. In an embodiment, the verification device 204 can be implemented as an independent print rendering verification system.

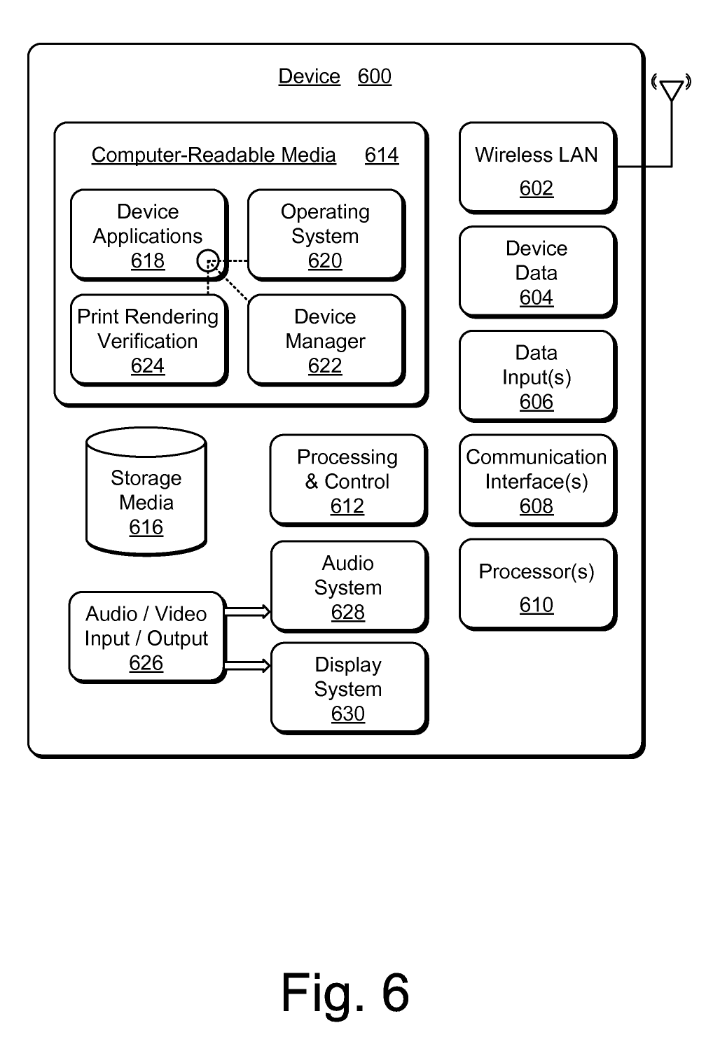

The computer device 202 and the verification device 204 can each be implemented with processors, communication components, data inputs, memory components, processing and control circuits, and a print rendering system. Computer device 202 and/or the verification device 204 can also be implemented with any number and combination of differing components as described with reference to the example device shown in FIG. 6. The devices may also be associated with a user (i.e., a person) and/or an entity that operates the device such that a device describes logical devices that include users, software, and/or a combination of devices.

In this example, verification device 204 includes one or more processors 212 (e.g., any of microprocessors, controllers, and the like) that process various computer-executable instructions to implement embodiments of print rendering verification. Alternatively or in addition, verification device 204 can be implemented with any one or combination of hardware, firmware, or fixed logic circuitry that is implemented in connection with processing and control circuits. Although not shown, verification device 204 can include a system bus or data transfer system that couples the various components within the device, or to other devices. Verification device 204 can also include communication interfaces that can be implemented as a serial and/or parallel interface, a wireless interface, any type of network interface, a modem, and/or as any other type of communication interface. The communication interfaces provide connection and/or communication links between verification device 204 and a communication network (e.g., LAN, WLAN) and/or other computer devices.

Verification device 204 can also include a device manager 214 (e.g., a control application, software application, signal processing and control module, code that is native to a particular device, a hardware abstraction layer for a particular device, etc.). Verification device 204 also includes storage media 216 to store or otherwise maintain various data and information, such as a reference image 218 and tolerance criteria 220 in embodiments of print rendering verification. The storage media 216 can be implemented as any type of memory, magnetic or optical disk storage, and/or other suitable electronic data storage. The storage media 216 can also be referred to or implemented as computer-readable media, such as one or more memory components, that provide data storage mechanisms to store various device applications and any other types of information and/or data related to operational aspects of verification device 204. For example, an operating system and/or software modules and components can be maintained as computer applications with storage media 216 and executed on processors 212.

Verification device 204 includes a print monitor 222, a raster image processor 224, an image comparator 226, and a verification module 228 as examples of device applications that can each be implemented as computer-executable instructions and executed by processors 212 to implement embodiments of print rendering verification. The print monitor 222 can be implemented to intercept the PDL print file 210 when a print job of a printable image is initiated, and the raster image processor 224 can be implemented to generate a raster image 230 from the PDL print file. The first time that a printable image is initiated as a print job from the print components 208, a raster image can be generated from the PDL print file and stored or otherwise maintained as the reference image 218.

The image comparator 226 can be implemented to compare the raster image 230 to the reference image 218 and then generate a delta that indicates a difference in the print quality of the printable image. The verification module 228 can be implemented to determine whether the printable image is an acceptable quality based on the comparison of the raster image 230 to the reference image 218, and/or based on a comparison of the delta with an acceptable quality deviation (e.g., tolerance criteria 220, user-specified pass criteria, etc.). If the printable image is determined to be an acceptable quality, a printer interface 232 can be implemented to communicate the PDL print file 210 to the printing device 206. Further details of the print rendering verification components implemented at verification device 204 are described with reference to similar devices shown in FIG. 1.

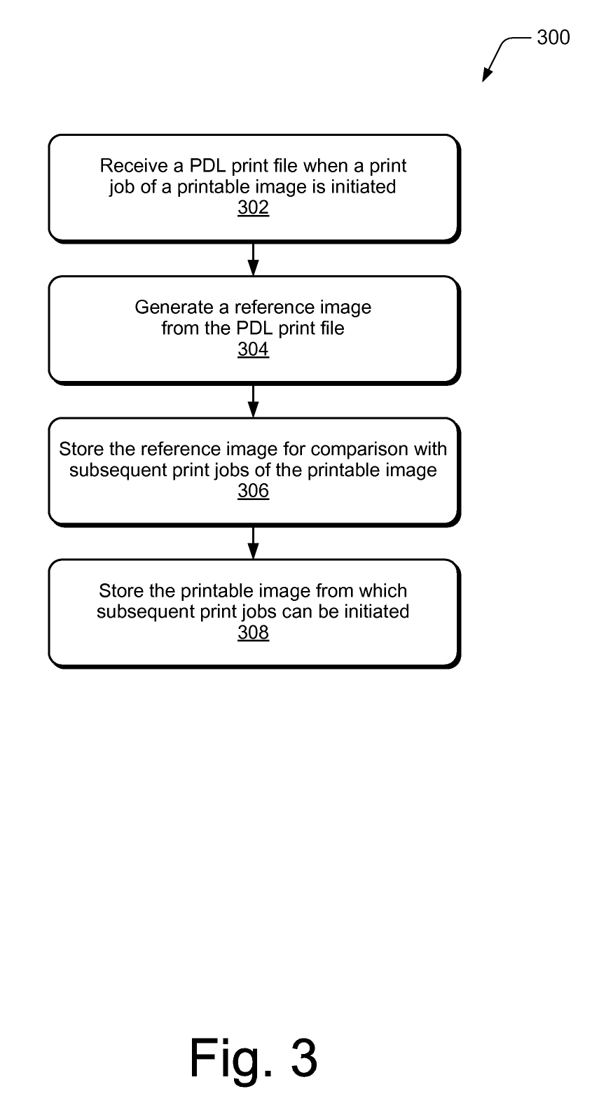

Example methods 300-500 are described with reference to respective FIGS. 3-5 in accordance with one or more embodiments of print rendering verification. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. The example method(s) may be described in the general context of computer-executable instructions, which can include software, applications, routines, programs, objects, components, data structures, procedures, modules, functions, and the like.

The method(s) may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 of print rendering verification. The order in which the method is described is not intended to be construed as a limitation, and any number of the described method blocks can be combined in any order to implement the method, or an alternate method.

At block 302, a PDL (Page Description Language) print file is received when a print job of a printable image is initiated. For example, print monitor 120 (FIG. 1) intercepts and receives the PDL print file 106 when generated by any one or more of the print components 104 that initiate a print job of a printable image.

At block 304, a reference image is generated from the PDL print file and, at block 306, the reference image is stored for comparison with subsequent print jobs of the printable image. For example, raster image processor 122 generates a raster image 132 from the PDL print file 106 the first time that a printable image is initiated as a print job from the print components 104. The raster image is then stored as reference image 134 that is the comparative standard by which to evaluate print quality of subsequent printable images. At block 308, the printable image from which subsequent print jobs can be initiated is stored. For example, the printable image, such as a document that is printed from application 112, is stored for subsequent print jobs.

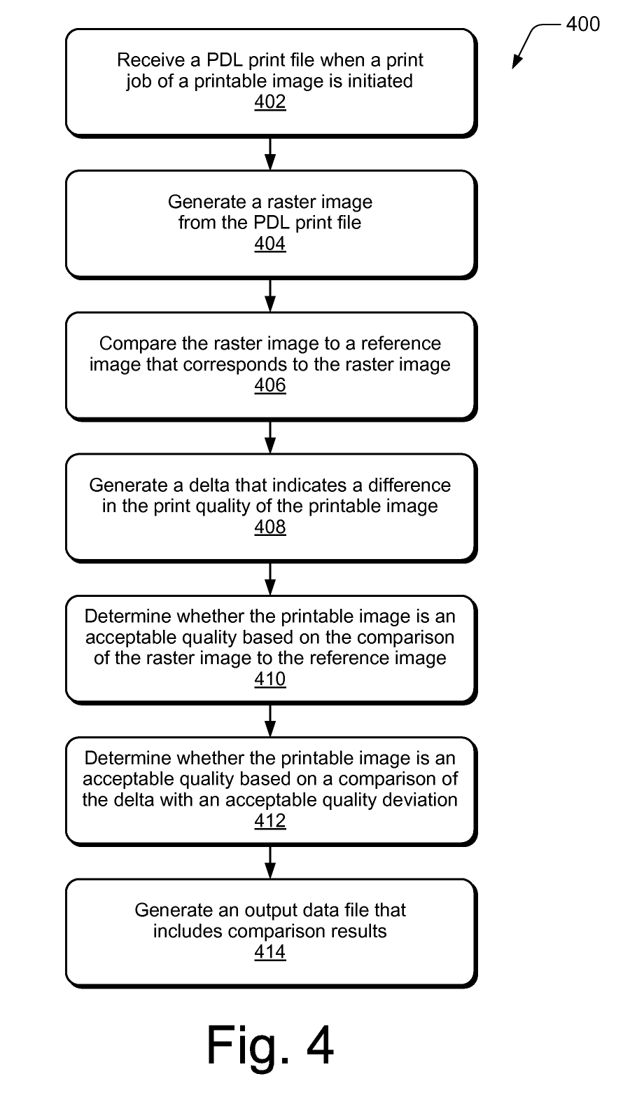

FIG. 4 illustrates example method(s) 400 of print rendering verification. The order in which the method is described is not intended to be construed as a limitation, and any number of the described method blocks can be combined in any order to implement the method, or an alternate method.

At block 402, a PDL (Page Description Language) print file is received when a print job of a printable image is initiated. For example, print monitor 120 (FIG. 1) intercepts and receives the PDL print file 106 when generated by any one or more of the print components 104 that initiate a print job of a printable image. At block 404, a raster image is generated from the PDL print file. For example, the raster image processor 122 generates raster image 132 from the PDL print file 106.

At block 406, the raster image is compared to a reference image that corresponds to the raster image. For example, the image comparator 124 compares the raster image 132 to the reference image 134 that corresponds to the particular raster image, where the reference image is the comparative standard by which to evaluate print quality of the printable image. At block 408, a delta is generated that indicates a difference in the print quality of the printable image. For example, the image comparator 124 generates a delta that indicates a difference in the print quality of the printable image when the raster image is compared to the reference image.

At block 410, a determination is made as to whether the printable image is an acceptable quality based on the comparison of the raster image to the reference image. Alternatively or in addition, at block 412, a determination is made as to whether the printable image is an acceptable quality based on a comparison of the delta with an acceptable quality deviation. For example, the verification module 126 determines whether the printable image is an acceptable quality based on the comparison of the raster image 132 to the reference image 134, and/or based on a comparison of the delta with an acceptable quality deviation (e.g., tolerance criteria 136, user-specified pass or fail criteria, etc.).

At block 414, an output data file is generated that includes comparison results. For example, verification module 126 generates an output data file 138 that includes comparison results when the raster image is compared to the reference image and/or when the delta is compared with the acceptable quality deviation.

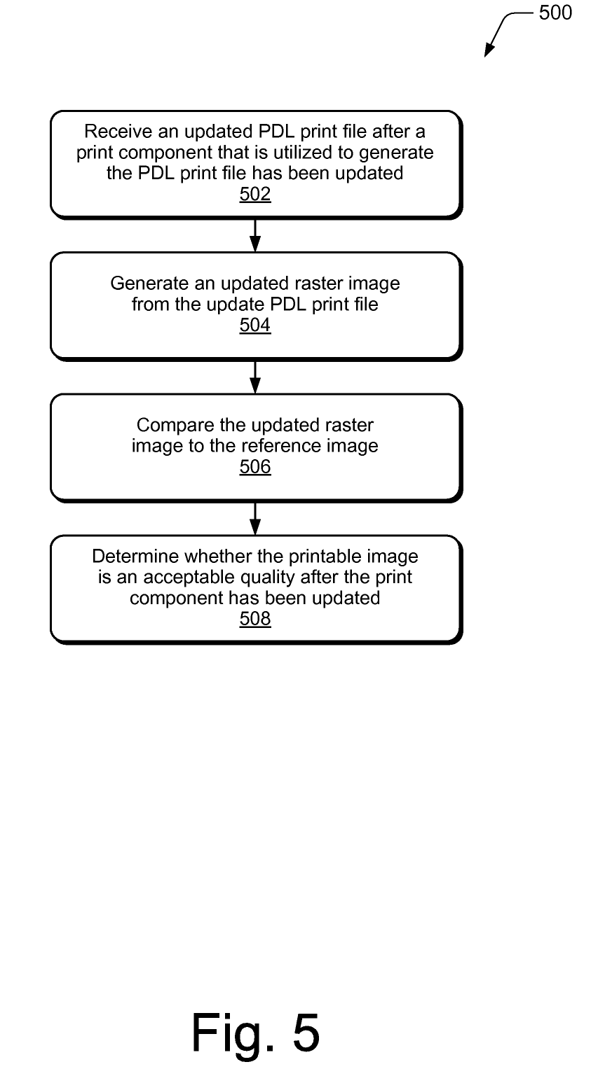

FIG. 5 illustrates example method(s) 500 of print rendering verification. The order in which the method is described is not intended to be construed as a limitation, and any number of the described method blocks can be combined in any order to implement the method, or an alternate method.

At block 502, an updated PDL print file is received after a print component that is utilized to generate the PDL print file has been updated and, at block 504, an updated raster image is generated from the updated PDL print file. For example, after a software update to a print component 104 that is utilized to generate the PDL print file 106, a printable image can again be initiated as a print job. The print monitor 120 intercepts and receives the updated PDL print file 106 and the raster image processor 122 generates an updated raster image 132 from the updated PDL print file 106. The updated PDL print file 106 is generated when a subsequent print job of the printable image is initiated from the print components 104.

At block 506, the updated raster image is compared to the reference image and, at block 508, a determination is made as to whether the printable image is an acceptable quality after the print component has been updated. For example, the image comparator 124 determines whether the printable image is still of an acceptable quality when the resultant raster image 132 that is generated from the updated PDL print file 106 is compared to the reference image 134. Additionally, the verification module 126 determines whether the printable image is the acceptable quality after the print component has been updated.

FIG. 6 illustrates various components of an example device 600 that can be implemented as any type of computer device or verification device as described with reference to FIG. 2 to implement embodiments of print rendering verification. In embodiment(s), device 600 can be implemented as any one or combination of a wired and/or wireless device, as any form of computer device, portable computer device, media device, image processing and/or rendering device, appliance device, gaming device, electronic device, and/or as any other type of device. Device 600 may also be associated with a user (i.e., a person) and/or an entity that operates the device such that a device describes logical devices that include users, software, firmware, and/or a combination of devices.

Device 600 includes wireless LAN (WLAN) components 602 that enable wireless communication of device data 604 (e.g., received data, data that is being received, data scheduled for broadcast, data packets of the data, etc.). The device data 604 or other device content can include configuration settings of the device, media content stored on the device, and/or information associated with a user of the device. Media content stored on device 600 can include any type of audio, video, and/or image media content. Device 600 can also include one or more data inputs 606 via which any type of data, media content, and/or inputs can be received, such as music, television media content, recorded video content, and any other type of audio, video, and/or image content received from a content source which can then be processed, rendered, and/or displayed for viewing.

Device 600 can also include communication interfaces 608 that can be implemented as any one or more of a serial and/or parallel interface, a wireless interface, any type of network interface, a modem, and as any other type of communication interface. The communication interfaces 608 provide a connection and/or communication links between device 600 and a communication network by which other electronic, computing, and communication devices can communicate data with device 600.

Device 600 can include one or more processors 610 (e.g., any of microprocessors, controllers, and the like) which process various computer-executable instructions to control the operation of device 600 and to implement embodiments of print rendering verification. Alternatively or in addition, device 600 can be implemented with any one or combination of hardware, firmware, or fixed logic circuitry that is implemented in connection with processing and control circuits which are generally identified at 612. Although not shown, device 600 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 600 can also include computer-readable media 614, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like. Device 600 can also include a mass storage media device 616.

Computer-readable media 614 provides data storage mechanisms to store the device data 604, as well as various device applications 618 and any other types of information and/or data related to operational aspects of device 600. For example, an operating system 620 can be maintained as a computer application with the computer-readable media 614 and executed on processors 610. The device applications 618 can include a device manager 622 (e.g., a control application, software application, signal processing and control module, code that is native to a particular device, a hardware abstraction layer for a particular device, etc.). The device applications 618 can also include system components or modules for print rendering verification 624. In this example, the device applications 618 are shown as software modules and/or computer applications.

Device 600 can also include an audio and/or video input-output system 626 that provides audio data to an audio system 628 and/or provides video data to a display system 630. The audio system 628 and/or the display system 630 can include any devices that process, display, and/or otherwise render audio, video, and image data. Video signals and audio signals can be communicated from device 600 to an audio device and/or to a display device via an RF (radio frequency) link, S-video link, composite video link, component video link, DVI (digital video interface), analog audio connection, or other similar communication link. In an embodiment, audio system 628 and/or the display system 630 can be implemented as external components to device 600. Alternatively, the audio system 628 and/or the display system 630 can be implemented as integrated components of example device 600.

Although embodiments of print rendering verification have been described in language specific to features and/or methods, it is to be understood that the subject of the appended claims is not necessarily limited to the specific features or methods described. Rather, the specific features and methods are disclosed as example implementations of print rendering verification.

1. A method, comprising:
receiving a PDL (Page Description Language) print file when a print job of a printable image is initiated;
generating a raster image from the PDL print file;
comparing the raster image to a reference image that corresponds to the raster image, the reference image being a comparative standard by which to evaluate print quality of the printable image; and
determining whether the printable image is an acceptable quality based on said comparing the raster image to the reference image.

2. A method as recited in claim 1, further comprising generating a delta that indicates a difference in the print quality of the printable image when said comparing the raster image to the reference image, and wherein said determining whether the printable image is the acceptable quality is further based on a comparison of the delta with an acceptable quality deviation.

3. A method as recited in claim 1, further comprising generating an output data file that includes comparison results from said comparing the raster image to the reference image.

4. A method as recited in claim 1, further comprising:
receiving a reference PDL print file when a reference print job is initiated for the printable image;
generating the reference image from the reference PDL print file; and
storing the reference image for comparison with subsequent print jobs of the printable image.

5. A method as recited in claim 1, further comprising storing the printable image from which subsequent print jobs can be initiated.

6. A method as recited in claim 1, further comprising:
receiving an updated PDL print file after a print component that is utilized to generate the PDL print file has been updated, the updated PDL print file being generated when a subsequent print job of the printable image is initiated;
generating an updated raster image from the updated PDL print file;
comparing the updated raster image to the reference image; and
determining whether the printable image is the acceptable quality based on said comparing the updated raster image to the reference image after the print component has been updated.

7. A method as recited in claim 6, wherein the print component that is utilized to generate the PDL print file is at least one of a print driver, an operating system programmable graphic interface, or an application that initiates the print job of the printable image.

8. A print rendering verification system, comprising:
a print monitor configured to intercept a PDL (Page Description Language) print file when a print job of a printable image is initiated;
a raster image processor configured to generate a raster image from the PDL print file;
an image comparator configured to compare the raster image to a reference image that corresponds to the raster image, the reference image created as a comparative standard by which to evaluate print quality of the printable image; and
a verification module configured to determine whether the printable image is an acceptable quality based on the comparison of the raster image to the reference image.

9. A print rendering verification system as recited in claim 8, wherein the image comparator is further configured to generate a delta that indicates a difference in the print quality of the printable image when the raster image is compared to the reference image, and wherein the verification module is further configured to determine whether the printable image is an acceptable quality based on a comparison of the delta with an acceptable quality deviation.

10. A print rendering verification system as recited in claim 8, wherein the verification module is further configured to generate an output data file that includes comparison results when the raster image is compared to the reference image.

11. A print rendering verification system as recited in claim 8, wherein:
the print monitor is further configured to intercept a reference PDL print file when a reference print job of the printable image is initiated;
the raster image processor is further configured to generate the reference image from the reference PDL print file; and
a memory device configured to maintain the reference image for comparison with subsequent print jobs of the printable image.

12. A print rendering verification system as recited in claim 8, further comprising a memory configured to maintain the printable image from which subsequent print jobs can be initiated.

13. A print rendering verification system as recited in claim 8, wherein:
the print monitor is further configured to intercept an updated PDL print file after a print component that is utilized to generate the PDL print file has been updated, where the updated PDL print file is generated when a subsequent print job of the printable image is initiated;
the raster image processor is further configured to generate an updated raster image from the updated PDL print file;
the image comparator is further configured to compare the updated raster image to the reference image; and
the verification module is further configured to determine whether the printable image is the acceptable quality based on the comparison of the updated raster image to the reference image after the print component has been updated.

14. A print rendering verification system as recited in claim 13, wherein the print component that is utilized to generate the PDL print file is at least one of a print driver, an operating system programmable graphic interface, or an application that initiates the print job of the printable image.

15. One or more computer-readable media comprising computer-executable instructions that, when executed, initiate a print rendering verification system to:
generate a raster image from a PDL (Page Description Language) print file when a print job of a printable image is initiated;
compare the raster image to a reference image that corresponds to the raster image, the reference image created as a comparative standard by which to evaluate print quality of the printable image; and
determine whether the printable image is an acceptable quality based on the comparison of the raster image to the reference image.

16. One or more computer-readable media as recited in claim 15, further comprising computer-executable instructions that, when executed, initiate the print rendering verification system to:
generate a delta that indicates a difference in the print quality of the printable image when the raster image is compared to the reference image; and
determine whether the printable image is an acceptable quality based on a comparison of the delta with an acceptable quality deviation.

17. One or more computer-readable media as recited in claim 15, further comprising computer-executable instructions that, when executed, initiate the print rendering verification system to generate an output data file that includes comparison results when the raster image is compared to the reference image.

18. One or more computer-readable media as recited in claim 15, further comprising computer-executable instructions that, when executed, initiate the print rendering verification system to:
generate the reference image from a reference PDL print file that is received when a reference print job is initiated for the printable image; and
store the reference image for comparison with subsequent print jobs of the printable image.

19. One or more computer-readable media as recited in claim 15, further comprising computer-executable instructions that, when executed, initiate the print rendering verification system to:
generate an updated raster image from an updated PDL print file that is received after a print driver that is utilized to generate the PDL print file has been updated;
compare the updated raster image to the reference image; and
determine whether the printable image is the acceptable quality based on the comparison of the updated raster image to the reference image after the print driver has been updated.

20. One or more computer-readable media as recited in claim 15, further comprising computer-executable instructions that, when executed, initiate the print rendering verification system to:
generate an updated raster image from an updated PDL print file that is received after an operating system programmable graphic interface that is utilized to generate the PDL print file has been updated;
compare the updated raster image to the reference image; and
determine whether the printable image is the acceptable quality based on the comparison of the updated raster image to the reference image after the operating system programmable graphic interface has been updated.
